(19) United States
(12) Patent Application Publication
(10) Pub. No.: US 2005/0214400 A1
(43) Pub. Date: Sep. 29, 2005

(54) Blowing head with melt distribution

(75) Inventor: Rolf Hessenbruch, Remscheid (DE)

Correspondence Address: COHEN, PONTANI, LIEBERMAN & PAVANE, 551 FIFTH AVENUE, SUITE 1210, NEW YORK, NY, 10176, US

(73) Assignee: Kiefel Extrusion GmbH

(21) Appl. No.: 11/086,516

(22) Filed: Mar. 22, 2005

(30) Foreign Application Priority Data
Mar. 23, 2004 (DE) 10 2004 014 096.0

(51) Int. Cl. B29C 47/12

(52) U.S. Cl. 425/381.2

(57) ABSTRACT

A single-layer or multi-layer blowing head distributes melt essentially by horizontal spiral mandrel distributors. As a result, the usual dead spaces underneath the otherwise inclined spirals are avoided, which leads to better flow conditions in the blowing head and avoids formation of specks caused by long retention times. Furthermore, the overall height is reduced by the compact arrangement of the spirals.

The invention relates to a single-layer or multi-layer blowing head for films and other round bodies, in which the distribution of the melt over the circumference does not take place in the generally customary way, by means of inclined spirals arranged uniformly around the circumference, but instead essentially by means of horizontally arranged spirals which are only offset in the region of the next feed bore by approximately the height that corresponds to the width of the spirals and the width of the overflow gap. In the case of the customary blowing heads, the melt distribution is carried out by means of spirals arranged in an inclined manner. This inclined arrangement produces a region which fills with melt underneath the spirals. The space is caused by the fact that the parts forming the space have to be fitted or removed, and a certain amount of clearance is necessary for this. Although it is endeavored to keep this clearance small, it is unavoidable that it fills with melt. It has now been found that the melt penetrating into this space is also flushed out again, the time for which it is retained there possibly amounting to several days or even weeks. However, this leads to thermal degradation of the melt and consequently to the formation of specks, that is to say burnt particles of plastic are repeatedly flushed out. This leads to significant losses in quality.

The purpose of the present invention is to avoid this disadvantage. To this end, it is necessary to conduct the melt in such a way that a space in which it can be retained for a long time cannot form in the region of the spirals. This is achieved by an arrangement of spirals which avoids the dead space. To this end, the spirals are arranged essentially horizontally and placed so close to the sealing surface that the entire region is optimally flowed through and consequently also flushed. The invention is explained in more detail with reference to the accompanying drawings.

The invention is explained in more detail on the basis of exemplary embodiments represented in the accompanying drawings, in which:

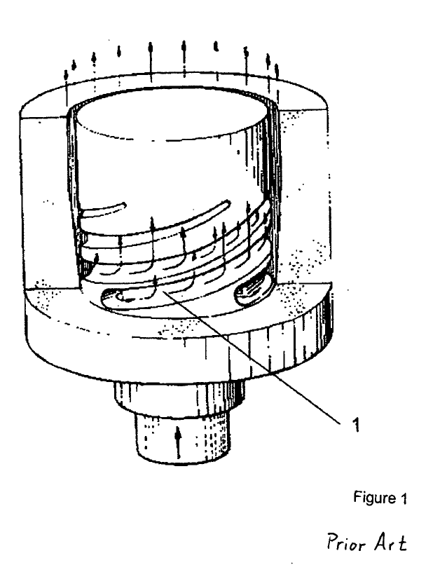

FIG. 1 schematically shows a blowing head with an arrangement of inclined spirals;

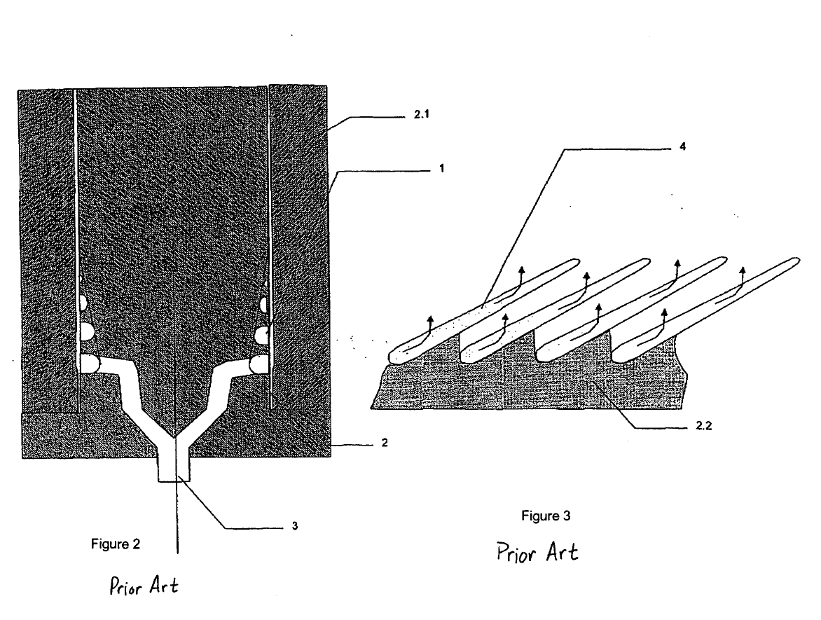

FIG. 2 shows a section through such a blowing head;

FIG. 3 shows the developed projection of these spirals;

FIG. 4 shows the developed projection of the arrangement of spirals according to the invention;

FIG. 4.1 shows various spiral configurations according to the invention;

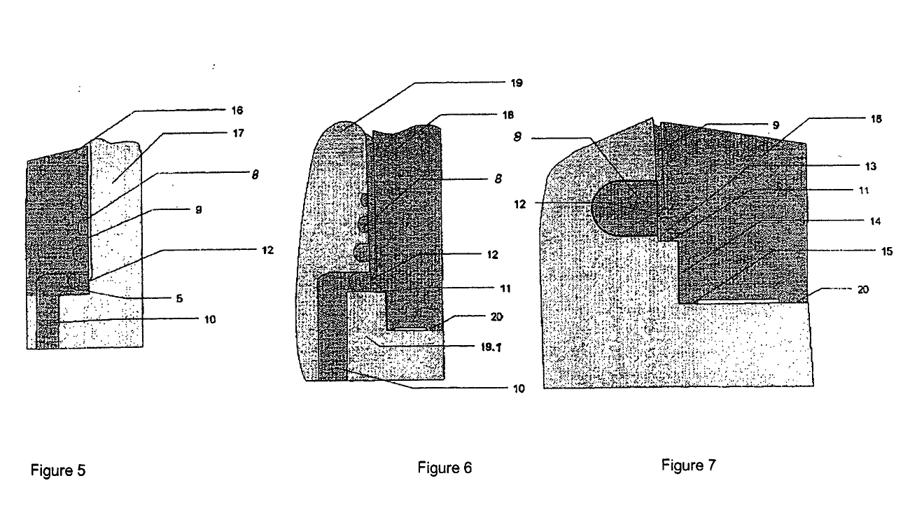

FIG. 5 shows a section through a blowing head in the region of the beginning of the spiral;

FIG. 6 shows another section through a blowing head in the region of the beginning of the spiral; and

FIG. 7 shows a detailed representation of FIG. 6.

FIG. 1 schematically shows the construction of a blowing head with inclined spiral mandrel distributors 1. The melt comes from the center, flows into the spirals and is distributed by continuously flowing out of the spirals 1 via the overflow gap to the blowing head outlet.

FIG. 2 shows a section through such a blowing head. The melt flows out of the central feed bore 3 into the spirals 1. Underneath the spirals, a small gap 2 is represented. This gap 2 is intended to be as small as possible, to minimize the entry of melt into this space 2. This gap 2 is necessary to allow the outer ring 2.1 to be fitted.

FIG. 3 shows the developed projection of the spirals 4 and the space 2.2 lying thereunder, into which the melt flows. This space 2.2 is flushed very poorly, since the melt normally flows only in the direction of the outlet. However, it has been found that, in this space 2.2, the melt will, after it has flowed in, also slowly be flushed out again. This process may take several days; in the meantime, the melt degrades and is flushed out again as burnt specks. This may mean that specks are continually produced and flushed out.

The solution according to the invention provides for this region to be kept as small as possible or avoided entirely.

FIG. 4 shows a developed projection of the solution according to the invention. The spirals 8 are horizontally mounted. They are supplied with melt via feed bore 10. The horizontal arrangement has the effect that the space 5 underneath the spirals 8 is brought to a very small volume. The spirals remain in the lowermost region up to the next feed bore 10 and are then taken over by the next spiral, the previous spiral extending away at an angle upward and then running parallel to the lower spiral, the new plane being displaced upward by the width of the spiral 21 and the overflow gap 22. In the case represented, four-fold superposing is therefore obtained. In spite of the four-fold superposing, the overall height of all the spirals, with the height 7, is small in comparison with the conventional arrangement. The cross section 6 of the individual spirals 8 decreases over the length of the spirals, the degree of cross-sectional reduction being potentially dependent on various factors.

FIG. 4.1 shows other configurations of the spirals. Spiral 8.1 would lead to five-fold superposing, spiral 8.2 to three-fold superposing.

FIG. 5 shows a detail of a blowing head in the region of the arrangement of spirals. The inner mandrel 16 is cylindrical and is inserted into the pot-shaped outer casing 17. For production engineering reasons, the beginning of the spiral 6 is therefore set very low, so that the dead space 5 is very small. In the case represented, the overflow gap 9 begins at approximately half the height 12 of the lower plane of the spirals.

In FIG. 6, the inner mandrel comprises a cylindrical part and a supporting ring 19.1. This form does not normally allow the spirals to be produced at the lowest point of the melt channel. To be able nevertheless to set the spirals at the lowest point, a small step 11 is provided, and this is at the same time the sealing surface. Since it has a diameter that is only a little larger than the cylindrical surface of the spiral ring, it is no problem for the spirals to be produced at this point. The outer casing 18 is actually accepted on the pressure-bearing surface 20 and the sealing surface 11, the pressure-bearing surface 20 having a clearance of one hundredth of a millimeter in the untightened state.

FIG. 7 shows the details from FIG. 6 once again in an enlarged form. The sealing surface 11 is located directly at the lower plane of the spirals 6. This produces a very small dead space 13, which is only 1-2 mm high. The annular surface 15 does not serve as a sealing surface but as a supporting surface. With the outer casing 18, it forms a small air gap of a few hundredths of a millimeter, while the annular surface 20 is formed as a supporting surface. In this way it is ensured that the full contact pressure acts on the pressure-bearing surface 15. In the case represented, the overflow gap 9 begins at point 12. The point 12 may, however, also be higher or lower.

1-6. (canceled)

7. A blowing head for extruding single-layer or multi-layer films or tubes, with a spiral mandrel distributor system for distributing melt over a circumference including a cylindrical spiral mandrel and an outer casing defining a melt channel therebetween, said spiral mandrel having a vertical longitudinal axis and defining open spiral channels on an outer circumference open to the melt channel, each of the spiral channels being respectively connected to a feed bore for receiving melt, said spirals extending substantially horizontally on said spiral mandrel and extending at an angle upward proximate successive circumferential regions of the feed bores by a vertical distance of a width of the spiral channel and an overflow gap.

8. The blowing head of claim 7, wherein each of the spiral channels has an inlet end for receiving melt from the feed bore and an outlet end, a cross-sectional area of each of the spiral channels decreasing continuously toward the outlet end.

9. The blowing head of claim 7, wherein the spiral channels are vertically superposed by a number that is greater by one than the number of times each of the spiral channels is angled upward.

10. The blowing head of claim 7, wherein a first segment of each of the spiral channels connected to the feed bore is arranged directly at a sealing surface of the melt channel, the sealing surface being arranged between said spiral mandrel and said outer casing, whereby a space between the spiral channels and a bottom of the melt channel is minimized.

11. The blowing head of claim 10, wherein a lower edge of the first segment of each of the spiral channels lies on the same plane as said sealing surface.

12. The blowing head of claim 10, wherein said cylindrical mandrel includes a vertical section under a lower edge of the first segment of each of the spiral channels and adjoining the sealing surface for centering said cylindrical mandrel.
